(19) United States
(12) Patent Application Publication
(10) Pub. No.: US 2022/0125685 A1
(43) Pub. Date: Apr. 28, 2022

(54) Oral Device For A Baby

(71) Applicant: Nina D. Farzin, Potomac, MD (US)

(72) Inventor: Nina D. Farzin, Potomac, MD (US)

(21) Appl. No.: 17/512,199

(22) Filed: Oct. 27, 2021

Related U.S. Application Data
(60) Provisional application No. 63/106,295, filed on Oct. 27, 2020.

(51) Int. Cl. A61J 17/02; A61J 17/00; A46B 5/02; A46B 15/00

(52) U.S. Cl. CPC A61J 17/02; A61J 17/109; A46B 2200/1086; A46B 15/0089; A46B 2200/1026; A46B 5/023

(57) ABSTRACT

An oral device for a baby is disclosed herein. The oral device includes a head portion, the head portion including one of: (i) a plurality of bristles for brushing gums and/or teeth of a baby, or (ii) a plurality of protrusions for stimulating gums and/or emerging teeth of the baby; a stop portion connected to the head portion, the stop portion sized to prevent over-insertion of the oral device into the mouth of the baby; and a handle portion connected to the stop portion, the handle portion configured to be grasped by the baby or another person for holding and/or manipulating the oral device.

### CROSS-REFERENCE TO RELATED APPLICATIONS

This patent application claims priority to, and incorporates by reference in its entirety, U.S. Provisional Patent Application No. 63/106,295, entitled “Teether For A Baby”, filed on Oct. 27, 2020.

### STATEMENT REGARDING FEDERALLY SPONSORED RESEARCH OR DEVELOPMENT

Not Applicable.

### NAMES OF THE PARTIES TO A JOINT RESEARCH AGREEMENT

Not Applicable.

### INCORPORATION BY REFERENCE OF MATERIAL SUBMITTED ON A COMPACT DISK

Not Applicable.

### BACKGROUND OF DISCLOSURE

### 1. Field of the Disclosure

The disclosure generally relates to an oral device for a baby. More particularly, the disclosure relates to an oral device for a baby that is configured to be used as a baby teether and/or toothbrush.

### 2. Background

Conventional oral devices for babies, such as conventional teethers and toothbrushes for babies, do not prevent the devices from being inserting too far into the baby's mouth, and could potentially be a choking hazard or cause the baby to gag. Functionally, conventional toothbrushes are hard for a baby to hold and cannot work to brush both gums and teeth, while conventional teethers are just something for the baby to chew on. Additionally, conventional oral devices for babies are not made of premium materials, and are typically hard to the touch. Other conventional oral devices for babies do not have a good balance of functionality and effectiveness, while also being cute and friendly for a baby to use. Solutions to these and potentially other problems are needed.

For example, what is needed is an oral device for a baby that includes a stop portion for preventing the oral device from being over-inserted into the mouth of the baby. Moreover, an oral device for a baby is needed that is able to be used to soothe and/or brush gums and teeth of the baby. Furthermore, there is a need for an oral device for a baby that includes a handle portion for facilitating the grasping of the oral device by a user.

### SUMMARY OF THE DISCLOSURE

Accordingly, the present disclosure is directed to an oral device for a baby that substantially obviates one or more problems resulting from the limitations and deficiencies of the related art.

In accordance with one or more embodiments of the present disclosure, there is provided an oral device for a baby that includes a head portion, the head portion including one of: (i) a plurality of bristles for brushing gums and/or teeth of a baby, or (ii) a plurality of protrusions for stimulating gums and/or emerging teeth of the baby; a stop portion connected to the head portion, the stop portion sized to prevent over-insertion of the oral device into the mouth of the baby; and a handle portion connected to the stop portion, the handle portion configured to be grasped by the baby or another person for holding and/or manipulating the oral device.

In a further embodiment of the present disclosure, the head portion comprises the plurality of bristles for brushing gums and/or teeth of the baby, and the head portion further comprises a central stem portion connected to the stop portion, the plurality of bristles extending from one or more sides of the central stem portion.

In yet a further embodiment, the plurality of bristles of the head portion are arranged around the entire circumference of the central stem portion.

In still a further embodiment, the head portion comprises the plurality of protrusions for stimulating gums and/or emerging teeth of the baby, and the head portion further comprises a central stem portion connected to the stop portion, the plurality of protrusions extending outwardly from one or more sides of the central stem portion.

In yet a further embodiment, the plurality of protrusions of the head portion are arranged around the entire circumference of the central stem portion.

In still a further embodiment, the stop portion is in a shape of an animal head.

In yet a further embodiment, the animal head forming the stop portion is a bear head.

In still a further embodiment, the handle portion comprises a base portion and a shaft portion connected to the base portion, the shaft portion of the handle portion being connected to the stop portion.

In yet a further embodiment, the base portion of the handle portion comprises one or more protrusions extending from one or more outer surfaces of the base portion.

In still a further embodiment, the base portion has a substantially disk shape, and the one or more protrusions extend from one or more outer disk surfaces.

In yet a further embodiment, the handle portion comprises a loop portion connected to the stop portion.

In still a further embodiment, the loop portion comprises one or more protrusions extending from one or more outer surfaces of the loop portion.

In yet a further embodiment, the stop portion comprises one or more protrusions extending from one or more outer surfaces of the stop portion.

In still a further embodiment, the stop portion is in a shape of an animal head, and the one or more protrusions extend from one or more outer ear surfaces of the animal head.

In yet a further embodiment, the oral device is formed from a flexible polymeric material.

In still a further embodiment, the flexible polymeric material forming the oral device comprises silicone.

In yet a further embodiment, the flexible polymeric material forming the oral device does not comprise latex, bisphenol A, or polyvinyl chloride.

In accordance with one or more other embodiments of the present disclosure, there is provided an oral device for a baby that includes a head portion, the head portion including one of: (i) a plurality of bristles for brushing gums and/or teeth of a baby, or (ii) a plurality of protrusions for stimulating gums and/or emerging teeth of the baby; a stop portion connected to the head portion, the stop portion sized to prevent over-insertion of the oral device into the mouth of the baby; and a handle portion connected to the stop portion, the handle portion configured to be grasped by the baby or another person for holding and/or manipulating the oral device, the handle portion including one of: (i) a base portion and a shaft portion, the shaft portion connecting the base portion to the stop portion, or (ii) a loop portion connected to the stop portion.

In a further embodiment of the present disclosure, the handle portion comprises the base portion and the shaft portion, the base portion having a substantially disk shape.

In still a further embodiment, the handle portion comprises the loop portion, the loop portion being in a form of an enclosed loop configured to be grasped by the baby or the other person.

It is to be understood that the foregoing general description and the following detailed description are merely exemplary and explanatory in nature. As such, the foregoing general description and the following detailed description should not be construed to limit the scope of the appended claims in any sense.

### BRIEF DESCRIPTION OF THE SEVERAL VIEWS OF THE DRAWINGS

The device will now be described, by way of example, with reference to the accompanying drawings, in which:

FIG. 1 is a frontal perspective view of an oral device for a baby, according to a first illustrative embodiment of the disclosure;

FIG. 2 is a front elevational view of the oral device shown in FIG. 1;

FIG. 3 is a rear elevational view of the oral device shown in FIG. 1;

FIG. 4 is a first side view of the oral device shown in FIG. 1;

FIG. 5 is an opposite second side view of the oral device shown in FIG. 1;

FIG. 6 is a top plan view of the oral device shown in FIG. 1;

FIG. 7 is a bottom plan view of the oral device shown in FIG. 1;

FIG. 8 is a frontal perspective view of an oral device for a baby, according to a second illustrative embodiment of the disclosure;

FIG. 9 is a front elevational view of the oral device shown in FIG. 8;

FIG. 10 is a rear elevational view of the oral device shown in FIG. 8;

FIG. 11 is a first side view of the oral device shown in FIG. 8;

FIG. 12 is an opposite second side view of the oral device shown in FIG. 8;

FIG. 13 is a top plan view of the oral device shown in FIG. 8; and

FIG. 14 is a bottom plan view of the oral device shown in FIG. 8.

Throughout the figures, the same parts are always denoted using the same reference characters so that, as a general rule, they will only be described once.

### DETAILED DESCRIPTION OF ILLUSTRATED EMBODIMENT(S)

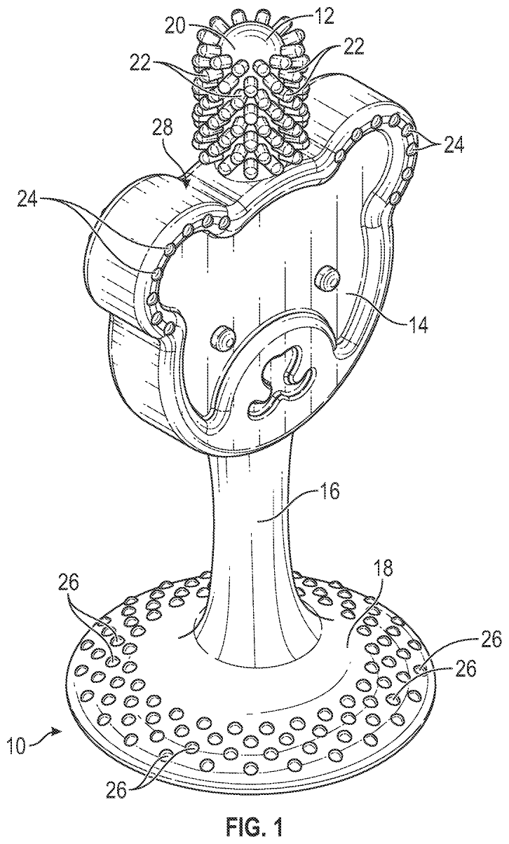

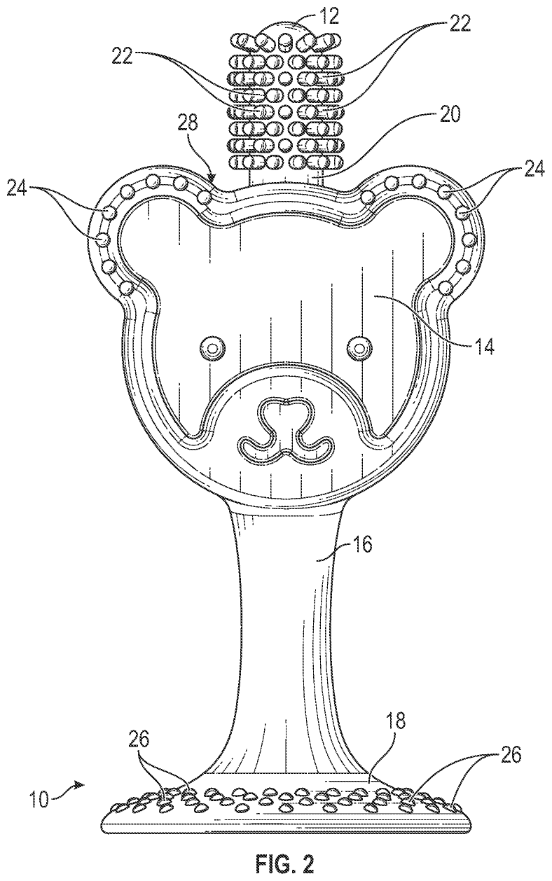

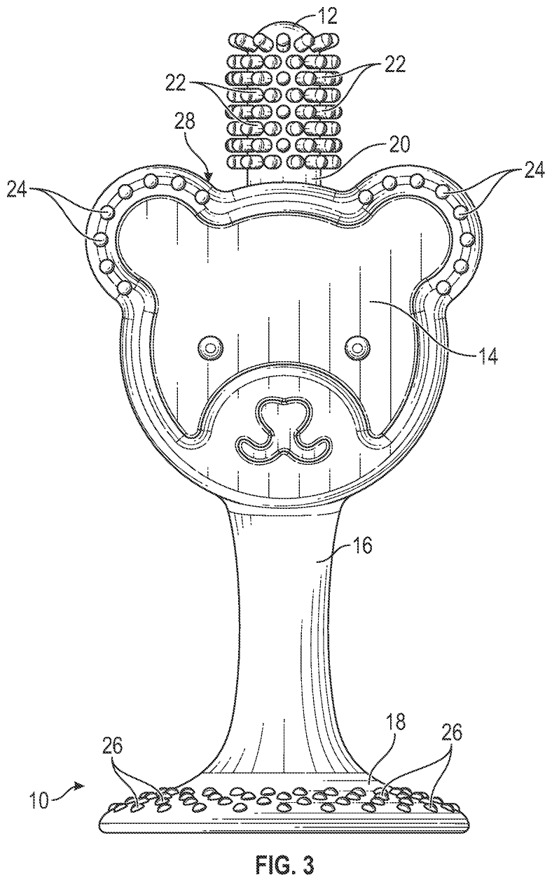

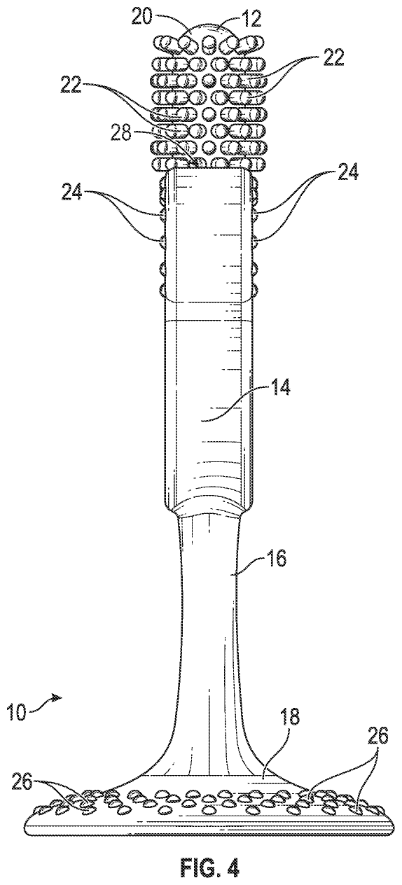

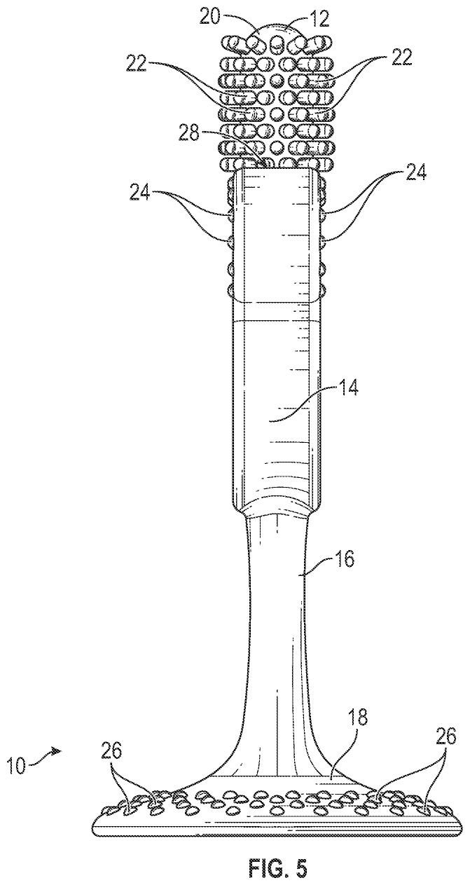

A first illustrative embodiment of an oral device for a baby is seen generally at 10 in FIGS. 1-7. With initial reference to FIGS. 1-3, it can be seen that the oral device 10 generally comprises a head portion 12, the head portion 12 including a plurality of bristles 22 for brushing gums and teeth of a baby; a stop portion 14 connected to the head portion 12, the stop portion 14 sized to prevent over-insertion of the oral device 10 into the mouth of the baby; and a handle portion 16, 18 connected to the stop portion 14, the handle portion 16, 18 configured to be grasped by a user for holding and/or manipulating the oral device 10. In the first illustrative embodiment, the oral device 10 may be in the form of a baby training toothbrush that works to soothe and comfort the gums of babies, as well as to brush their teeth.

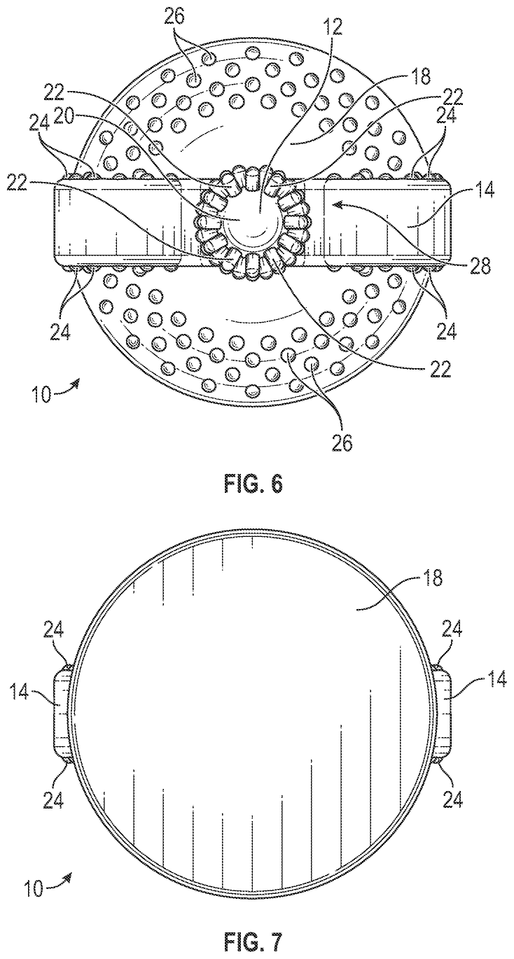

In the illustrative embodiment, referring again to FIGS. 1-3, it can be seen that the head portion 12 of the oral device 10 further comprises a central stem portion 20 connected to the stop portion 14. The plurality of bristles 22 extend from the outer circular side of the central stem portion 20 (see FIGS. 1-3). As best shown in FIGS. 1 and 6, in the illustrative embodiment, the plurality of bristles 22 of the head portion 12 are arranged around the entire circumference of the central stem portion 20 (i.e., the bristles 22 extend 360 degrees around the central stem portion 20). In the illustrative embodiment, the plurality of bristles 22 of the head portion 12 may have a length from about 2.5 millimeters to about 3.5 millimeters, inclusive (or a length between 2.5 and 3.5 millimeters, inclusive). More specifically, in the illustrative embodiment, the plurality of bristles 22 of the head portion 12 may have a length of approximately 3.0 millimeters or 3.0 millimeters. Also, in the illustrative embodiment, the plurality of bristles 22 of the head portion 12 may have a diameter from about 1.2 millimeters to about 2.0 millimeters, inclusive (or a diameter between 1.2 and 2.0 millimeters, inclusive). More specifically, in the illustrative embodiment, the plurality of bristles 22 of the head portion 12 may have a diameter of approximately 1.5 millimeters or 1.5 millimeters.

With reference again to FIGS. 1-3, it can be seen that, in the illustrative embodiment, the stop portion 14 is in a shape of an animal head, with the top of the head forming stop surface 28. More specifically, in the illustrative embodiment, the animal head forming the stop portion is a bear head (e.g., a “teddy bear” head). In other embodiments, the stop portion 14 may take on other suitable shapes, such as but not limited to, the head shapes of other animals (e.g., other caricature animal head shapes). Alternatively, a flat stop surface without any ornamentation can be used.

Turning again to FIGS. 1-3, in the illustrative embodiment, it can be seen that the handle portion 16, 18 comprises a base portion 18 and a shaft portion 16 connected to the base portion 18. As shown in these figures, the shaft portion 16 of the handle portion 16, 18 is connected to the stop portion 14. Also, with reference to the illustrative embodiment of FIGS. 1-6, it can be seen that the base portion 18 of the handle portion 16, 18 comprises a plurality of protrusions 26 extending from the top surface of the base portion 18. More specifically, in the illustrative embodiment, it can be seen that the base portion 18 has a substantially disk shape (see FIG. 1), and the plurality of protrusions 26 extend outwardly from the outer top disk surface.

Also, as best shown in FIGS. 1-3, in the illustrative embodiment, the stop portion 14 comprises a plurality of protrusions 24 extending from outer surfaces of the stop portion 14. More specifically, in the illustrative embodiment, it can be seen that the stop portion 14 is in a shape of an animal head (i.e., a bear head), and the plurality of protrusions 24 extend outwardly from outer ear surfaces of the animal head (i.e., outer ear surfaces of the bear head).

In the illustrative embodiment, the plurality of protrusions 24 on the stop portion 14 and the plurality of protrusions 26 on the base portion 18 comprise small bumps that are generally hemispherical in shape (see FIGS. 1-5). In other embodiments, the plurality of protrusions 24, 26 may take on other suitable shapes, such as but not limited to, generally cylindrical shapes. The generally flat bottom surface of the base portion 18 advantageously allows the oral device 10 to stand upright on a support surface (e.g., on a table).

In the illustrative embodiment, the oral device 10 is formed from a flexible polymeric material that does not comprise latex, bisphenol A (BPA), or polyvinyl chloride (PVC) (i.e., the material is latex-free, BPA-free, and PVC-free). More specifically, in the illustrative embodiment, the flexible polymeric material forming the oral device 10 comprises silicone that does not contain latex, BPA, or PVC. In the illustrative embodiment, the oral device 10 may be formed by injection molding from a liquid silicone material. In the illustrative embodiment, the silicone material forming the oral device 10 may have a Shore hardness rating (A scale) of 40 to 60. More specifically, in the illustrative embodiment, the silicone material forming the oral device 10 may have a Shore scale hardness rating of approximately 50 A (i.e., a hardness of approximately 50 on the Shore A hardness scale). In addition, in the illustrative embodiment, the silicone material forming the oral device 10 may comprise a high tensile strength silicone.

In the illustrative embodiment, the head portion 12 of the oral device 10 may have a length from about 15.0 millimeters to about 25.0 millimeters, inclusive (or a length between 15.0 and 25.0 millimeters, inclusive), and an outer diameter of about 10.0 millimeters to about 20.0 millimeters, inclusive (or an outer diameter between 10.0 and 20.0 millimeters, inclusive). More specifically, in the illustrative embodiment, the head portion 12 may have a length of approximately 20.0 millimeters or 20.0 millimeters, and the head portion 12 may have an outer diameter of approximately 16.0 millimeters or 16.0 millimeters. Also, in the illustrative embodiment, the stop portion 14 of the oral device 10 may have a width from about 40.0 millimeters to about 60.0 millimeters, inclusive (or a width between 40.0 and 60.0 millimeters, inclusive), and a length of about 30.0 millimeters to about 50.0 millimeters, inclusive (or a length between 30.0 and 50.0 millimeters, inclusive). More specifically, in the illustrative embodiment, the stop portion 14 may have a width of approximately 55.0 millimeters or 55.0 millimeters, and the stop portion 14 may have a length of approximately 45.0 millimeters or 45.0 millimeters. Further, in the illustrative embodiment, the handle portion 16, 18 of the oral device 10 may have an overall length from about 40.0 millimeters to about 60.0 millimeters, inclusive (or a length between 40.0 and 60.0 millimeters, inclusive), and the base portion 18 of the handle portion 16, 18 may have an outer diameter of about 40.0 millimeters to about 60.0 millimeters, inclusive (or an outer diameter between 40.0 and 60.0 millimeters, inclusive). More specifically, in the illustrative embodiment, the handle portion 16, 18 may have a length of approximately 45.0 millimeters or 45.0 millimeters, and the base portion 18 of the handle portion 16, 18 may have an outer diameter of approximately 50.5 millimeters or 50.5 millimeters. Also, in the illustrative embodiment, the oral device 10 may have an overall length from about 100.0 millimeters to about 120.0 millimeters, inclusive (or a length between 100.0 and 120.0 millimeters, inclusive). More specifically, in the illustrative embodiment, the oral device 10 may have an overall length of approximately 111.0 millimeters or 111.0 millimeters. In other embodiments, the components of the oral device 10 may have other suitable dimensions.

Now, with reference to FIGS. 1-3, the manner in which the oral device 10 of the first illustrative embodiment is used will be described. The head portion 12 of the oral device 10 is inserted into the baby's mouth. The baby can hold the oral device 10 himself or herself by grabbing the handle portion 16, 18 underneath the bear head 14. As the baby chews and moves the brush head 12 around in his or her mouth, the bristles 22 will brush against the gums and teeth, and work like a toothbrush to gently clean the gums and teeth. The soft silicone material of the illustrative oral device 10 makes the oral device comfortable and flexible for the baby to chew on. As mentioned above, the bear head 14 operates as a stopping mechanism to ensure the head portion 12 doesn't go too far into the baby's mouth. As babies do however, they will likely chew the entire area of the oral device 10. The oral device 10 is functional and safe for the baby to chew on, as the ears of the bear head 14 and bottom base portion 18 have small protrusions or bumps 24, 26 that will stimulate the gums of the baby in a similar way the bristles do, but in an even more gentle way.

In one or more illustrative embodiments, the aforedescribed oral device 10 is designed for a baby that is three months or older (i.e., 3+ months in age), and the oral device 10 works to soothe and comfort babies' gums, as well as brush their teeth (or single tooth). In one or more illustrative embodiments, the oral device 10 is made of an extra soft silicone that is gentle and flexible enough for a baby to safely chew on. The oral device 10 is designed to utilize the bear head 14 as a protective stopping mechanism, ensuring the oral device doesn't go too far into the mouth of the baby. This bear head 14 is both functional and adorable so that the cute bear design won't scare the baby. The top of the oral device 10 is fixed with a flexible silicone bristle brush 12 that can brush the teeth and/or gums of the baby. In one or more illustrative embodiments, the ears of the stop portion 14 and the base 18 comprise silicone bumps to stimulate the gums and mouth of the baby.

In one or more illustrative embodiments, the aforedescribed oral device 10 is a soft-to-the-touch and flexible baby toothbrush. The oral device 10 can be perfect for soothing any discomfort a teething baby may have. The soft bristles 22 of the oral device 10 act as a toothbrush that can gently brush the baby's gums and/or teeth. In one or more illustrative embodiments, the bear head stop portion 14 of the oral device 10 prevents the oral device 10 from going too far into the baby's mouth, and the bear head stop portion 14 provides a friendly and cute look that won't scare the baby. Advantageously, the oral device 10 of the first illustrative embodiment described above has a 360-degree cylindrical brush head portion 12 on top of the bear head stop portion 14 that allows young babies to be introduced to the idea of a brush head so as to ease the transition into more advanced oral care and brushing as they age.

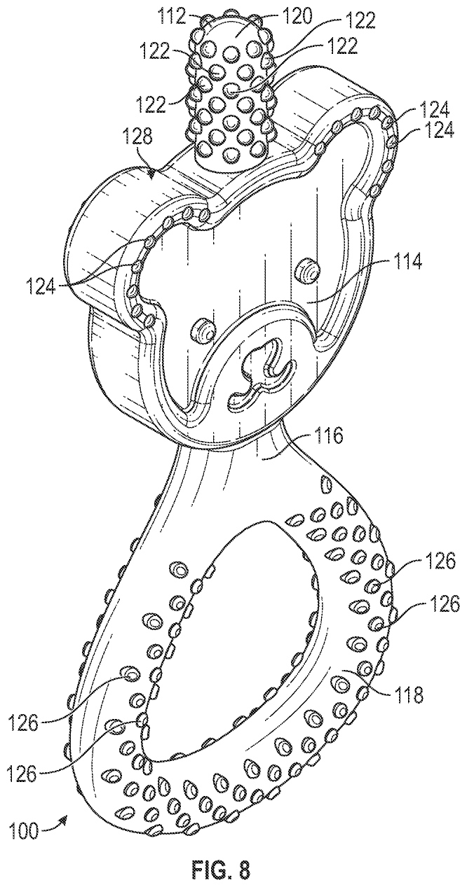

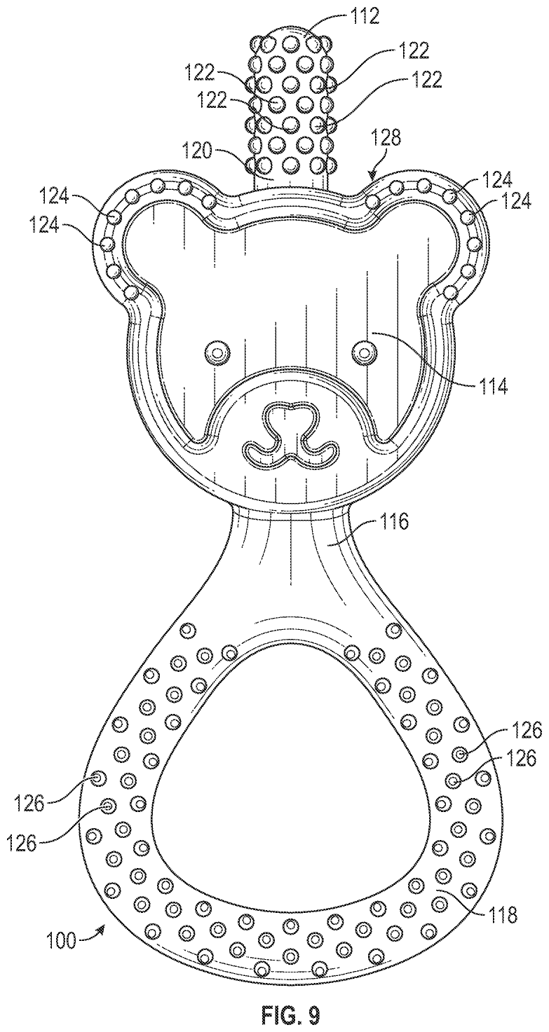

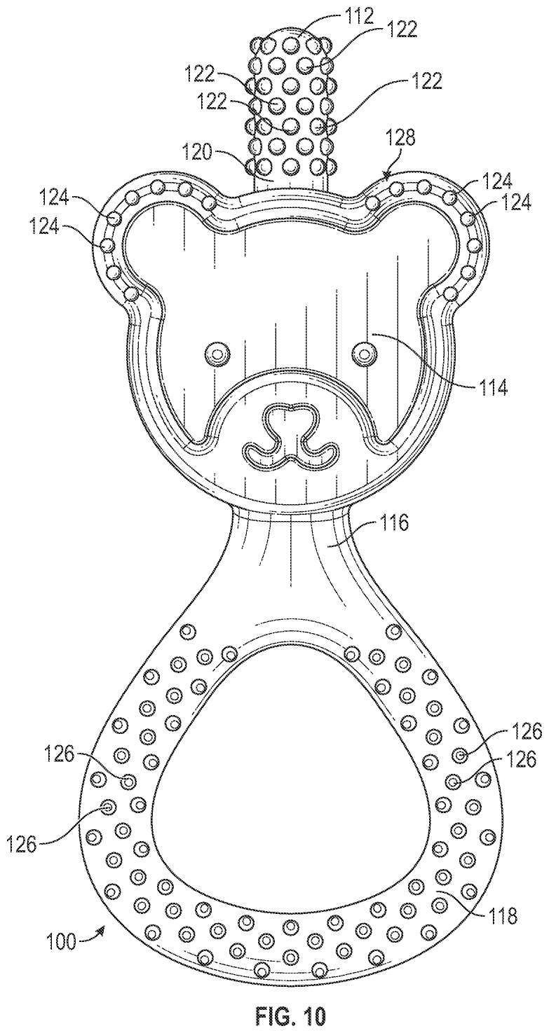

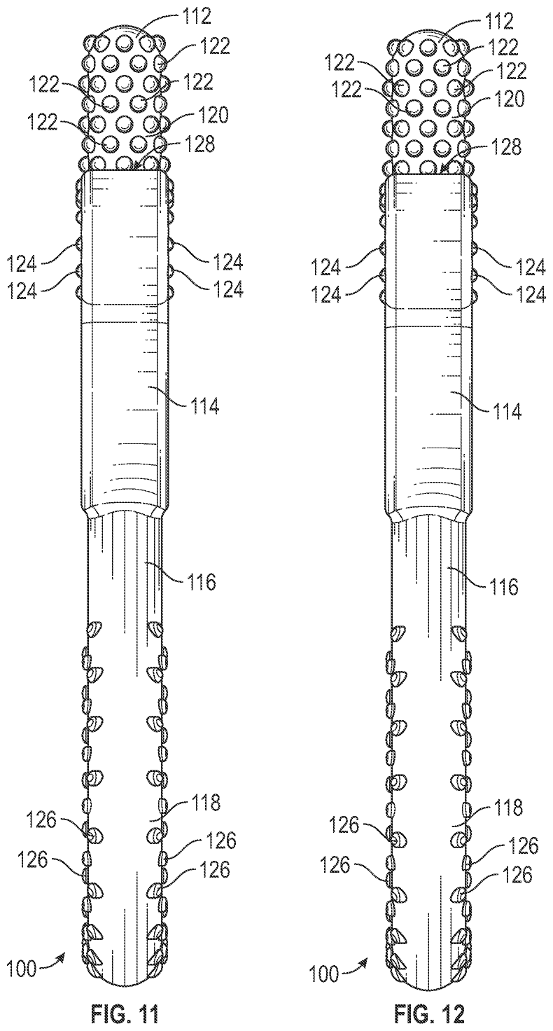

A second illustrative embodiment of an oral device for a baby is seen generally at 100 in FIGS. 8-14. With initial reference to FIGS. 8-10, it can be seen that the oral device 100 generally comprises a head portion 112, the head portion 112 including a plurality of protrusions 122 for stimulating gums and/or emerging teeth of a baby; a stop portion 114 connected to the head portion 112, the stop portion 114 sized to prevent over-insertion of the oral device 100 into the mouth of the baby; and a handle portion 116, 118 connected to the stop portion 114, the handle portion 116, 118 configured to be grasped by a user for holding and/or manipulating the oral device 100. In the second illustrative embodiment, the oral device 100 may be in the form of a baby teether that works to soothe and comfort the gums of babies, as they chew on the teether.

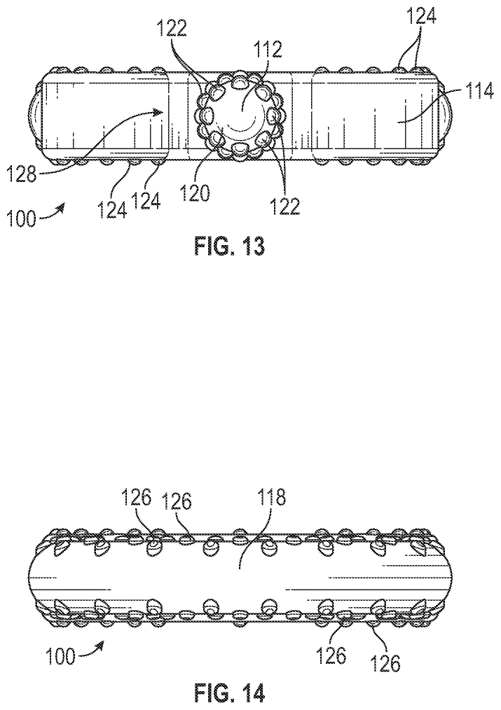

In the illustrative embodiment, referring again to FIGS. 8-10, it can be seen that the head portion 112 of the oral device 100 further comprises a central stem portion 120 connected to the stop portion 114. The plurality of protrusions 122 extend from the outer circular side of the central stem portion 120 (see FIGS. 8-10). As best shown in FIGS. 8 and 13, in the illustrative embodiment, the plurality of protrusions 122 of the head portion 112 are arranged around the entire circumference of the central stem portion 120 (i.e., the protrusions 122 extend 360 degrees around the central stem portion 120). Also, in the illustrative embodiment, each of the plurality of protrusions 122 has a generally hemispherical or dome shape. In the illustrative embodiment, the plurality of protrusions 122 of the head portion 112 may have a length from about 1.0 millimeters to about 2.0 millimeters, inclusive (or a length between 1.0 and 2.0 millimeters, inclusive). More specifically, in the illustrative embodiment, the plurality of protrusions 122 of the head portion 112 may have a length of approximately 1.5 millimeters or 1.5 millimeters. Also, in the illustrative embodiment, the plurality of protrusions 122 of the head portion 112 may have a diameter from about 1.0 millimeters to about 2.0 millimeters, inclusive (or a diameter between 1.0 and 2.0 millimeters, inclusive). More specifically, in the illustrative embodiment, the plurality of protrusions 122 of the head portion 112 may have a diameter of approximately 1.6 millimeters or 1.6 millimeters.

With reference again to FIGS. 8-10, it can be seen that, in the illustrative embodiment, the stop portion 114 is in a shape of an animal head, with the top of the head forming stop surface 128. More specifically, in the illustrative embodiment, the animal head forming the stop portion is a bear head (e.g., a “teddy bear” head). In other embodiments, the stop portion 114 may take on other suitable shapes, such as but not limited to, the head shapes of other animals (e.g., other caricature animal head shapes). Alternatively, a flat stop surface without any ornamentation can be used.

Turning again to FIGS. 8-10, in the illustrative embodiment, it can be seen that the handle portion 116, 118 comprises a loop portion 118 connected to the stop portion 114 by means of a short shaft portion 116. As shown in these figures, the loop portion 118 is in a form of an enclosed loop configured to be grasped by a baby or other person. Also, with reference to the illustrative embodiment of FIGS. 8-12 and 14, it can be seen that the loop portion 118 of the handle portion 116, 118 comprises a plurality of protrusions 126 extending from the outer curved surface of the loop portion 118.

Also, as best shown in FIGS. 8-10, in the illustrative embodiment, the stop portion 114 comprises a plurality of protrusions 124 extending from outer surfaces of the stop portion 114. More specifically, in the illustrative embodiment, it can be seen that the stop portion 114 is in a shape of an animal head (i.e., a bear head), and the plurality of protrusions 124 extend outwardly from outer ear surfaces of the animal head (i.e., outer ear surfaces of the bear head).

In the illustrative embodiment, the plurality of protrusions 124 on the stop portion 114 and the plurality of protrusions 126 on the loop portion 118 comprise small bumps that are generally hemispherical in shape (see FIGS. 8-12). In other embodiments, the plurality of protrusions 124, 126 may take on other suitable shapes, such as but not limited to, generally cylindrical shapes.

In the illustrative embodiment, the oral device 100 is formed from a flexible polymeric material that does not comprise latex, bisphenol A (BPA), or polyvinyl chloride (PVC) (i.e., the material is latex-free, BPA-free, and PVC-free). More specifically, in the illustrative embodiment, the flexible polymeric material forming the oral device 100 comprises silicone that does not contain latex, BPA, or PVC. In the illustrative embodiment, the oral device 100 may be formed by compression molding from a liquid silicone material. In the illustrative embodiment, the silicone material forming the oral device 100 may have a Shore hardness rating (A scale) of 40 to 60. More specifically, in the illustrative embodiment, the silicone material forming the oral device 100 may have a Shore scale hardness rating of approximately 50 A (i.e., a hardness of approximately 50 on the Shore A hardness scale). In addition, in the illustrative embodiment, the silicone material forming the oral device 100 may comprise a high tensile strength silicone.

In the illustrative embodiment, the head portion 112 of the oral device 100 may have a length from about 15.0 millimeters to about 25.0 millimeters, inclusive (or a length between 15.0 and 25.0 millimeters, inclusive), and an outer diameter of about 10.0 millimeters to about 20.0 millimeters, inclusive (or an outer diameter between 10.0 and 20.0 millimeters, inclusive). More specifically, in the illustrative embodiment, the head portion 112 may have a length of approximately 22.0 millimeters or 22.0 millimeters, and the head portion 112 may have an outer diameter of approximately 12.5 millimeters or 12.5 millimeters. Also, in the illustrative embodiment, the stop portion 114 of the oral device 100 may have a width from about 40.0 millimeters to about 60.0 millimeters, inclusive (or a width between 40.0 and 60.0 millimeters, inclusive), and a length of about 30.0 millimeters to about 50.0 millimeters, inclusive (or a length between 30.0 and 50.0 millimeters, inclusive). More specifically, in the illustrative embodiment, the stop portion 114 may have a width of approximately 55.0 millimeters or 55.0 millimeters, and the stop portion 114 may have a length of approximately 45.0 millimeters or 45.0 millimeters. Further, in the illustrative embodiment, the handle portion 116, 118 of the oral device 100 may have an overall length from about 50.0 millimeters to about 80.0 millimeters, inclusive (or a length between 50.0 and 80.0 millimeters, inclusive), and the loop portion 118 of the handle portion 116, 118 may have an outer width of about 40.0 millimeters to about 70.0 millimeters, inclusive (or an outer width between 40.0 and 70.0 millimeters, inclusive). More specifically, in the illustrative embodiment, the handle portion 116, 118 may have a length of approximately 65.0 millimeters or 65.0 millimeters, and the loop portion 118 of the handle portion 116, 118 may have an outer width of approximately 58.0 millimeters or 58.0 millimeters. Also, in the illustrative embodiment, the oral device 100 may have an overall length from about 120.0 millimeters to about 140.0 millimeters, inclusive (or a length between 120.0 and 140.0 millimeters, inclusive), and an overall width from about 10.0 millimeters to about 20.0 millimeters, inclusive (or a length between 10.0 and 20.0 millimeters, inclusive). More specifically, in the illustrative embodiment, the oral device 100 may have an overall length of approximately 131.0 millimeters or 131.0 millimeters, an overall width of approximately 13.4 millimeters or 13.4 millimeters. In other embodiments, the components of the oral device 100 may have other suitable dimensions.

Now, with reference to FIGS. 8-10, the manner in which the oral device 100 of the second illustrative embodiment is used will be described. The head portion 112 of the oral device 100 is inserted into the baby's mouth. The baby can hold the oral device 100 himself or herself by grabbing the by grabbing the loop portion 118 underneath the bear head 114. As the baby chews and moves the teether head portion 112 around in his or her mouth, the protrusions 122 will stimulate gums and emerging teeth. The soft silicone material of the illustrative oral device 100 makes it comfortable and flexible for the baby to chew anywhere on the oral device 100. As mentioned above, the bear head 114 operates as a stopping mechanism to ensure the head portion 112 doesn't go too far into the baby's mouth. The ears of the bear head stop portion 114 and the bottom loop 118 have small protrusions or bumps 124, 126 that will stimulate the gums in a similar, but even more gentle way, to how the protrusions 122 on the cylindrical head portion 112 operate. As new teeth emerge, the baby can easily transition to the toothbrush-type oral device 10 described above in the first embodiment, having already been introduced to the idea of inserting a toothbrush-shaped head portion 112 into his or her mouth for chewing (and eventually, brushing as part of the independent oral care).

In one or more illustrative embodiments, the aforedescribed oral device 100 is designed for a baby that is three months or older (i.e., 3+ months in age), and the oral device 100 works to soothe and comfort babies' gums, as well as brush their teeth (or single tooth). In one or more illustrative embodiments, the oral device 100 is made of an extra soft silicone that is gentle and flexible enough for a baby to safely chew on. Also, the oral device 100 is designed to offer many different shapes and textures for the baby to explore (e.g., with the different protrusions 122, 124, 126 and the varying component shapes of the device 100). The oral device 100 is further designed to utilize the bear head 114 as a protective stopping mechanism, ensuring the oral device doesn't go too far into the mouth of the baby. This bear head 114 is both functional and adorable so that the cute bear design won't scare the baby. The top of the oral device 100 is fixed with a flexible silicone bristle head portion 112 that is covered in small hemispherical protruding buttons or protrusions 122 to give the baby varied pleasing textures to gnaw on. The ears of the bear head stop portion 114 and the teether loop portion 118 feature small protrusions or bumps 124, 126 to stimulate the gums and mouth. Advantageously, the oral device 100 of the second illustrative embodiment described above has a 360-degree cylindrical head portion 112 on top of the bear head stop portion 114 that allows young babies to be introduced to the idea of a brush-like head so as to ease the transition into more advanced oral care and brushing as they age. If desired, the oral device 100 of the second illustrative embodiment may be cooled in a refrigerator prior to use in order to help soothe the gums of the baby.

It is readily apparent that the aforedescribed oral device 10, 100 for a baby offers numerous advantages. First, oral device 10, 100 includes a stop portion 14, 114 for preventing the oral device from being over-inserted into the mouth of the baby. Secondly, the oral device 10, 100 is able to be used to soothe and/or brush gums and teeth of the baby. Finally, the oral device 10, 100 includes a handle portion 16, 18, 116, 118 for facilitating the grasping of the oral device 10, 100 by a user.

The example embodiments of FIGS. 1 and 8 are single molded structures that are formed using a molding operation and the structural elements are not separable.

Benefits of the handle and stand 16, 18 of the illustrative embodiment of FIG. 1 include that the stand permits the head portion 12 to be placed upright on a support surface (e.g., a table), and away from surfaces (e.g., to avoid contact with germs or dust) and the handle and stand 16, 18 provide an attractive item for reaching by a baby when the device 10 is upright.

The head portion 12, 112 and the stop portion 14, 114 are cooperatively configured to permit a portion of the head portion 12, 112 to be inserted into the baby's mouth without reaching in too far such that it would cause the baby to gag or choke on the top of the head portion 12, 112. Such dimensions are illustratively described herein.

The combination of the embodiments of FIG. 1 and FIG. 8 provide an option for a set of combined tools that by having common physical structures, such as a common animal head, provide a powerful tool for gradually training or educating a child to move from a first device 100 in FIG. 8 to a second device 10 in FIG. 1. The combination can be a kit and/or method of use of the devices.

In the illustrative embodiments, the stop surface 28, 128 of the stop portion 14, 114 has a generally flat profile at least in relation to the head portion 12, 112 and the top view profile (cross section) of the head portion 12, 112 extends to at or wider than the thickness of the stop portion 14, 114. This can have certain advantages. Other variations are also contemplated.

The head portion 12, 112 is configured to be a linear or generally linear protrusion that extends upward from the top surface 28, 128 of the bear head stop portion 14, 114 and the protrusions 22, 122 extend outwardly from the central stem 20, 120 of the head portion 12, 112 (laterally/in perpendicular direction in relation to the central stem surface of the head portion 12, 112 from which the protrusions 22, 122 extend). This linear arrangement is configured to allow the baby to align the head portion 12, 112 (a large protrusion) with the dental teeth line for the growing teeth and to bite directly on to the linear line (large protrusion) in a way that the protrusion can apply pressure or massage the dental line across a row of teeth (back row of teeth on one side) all together. The cooperative relation with the stop portion 14, 114 permits for this operation to happen without causing gagging. Other shapes or configuration for the head portion are contemplated.

The softness of the structure of the oral devices 10, 100 can potentially provide a positive feedback to the baby by way of providing a chewing sensation. If desired, the oral device or portions of the device can have a hard surface.

Embodiments of the oral device 10, 100 are not necessarily limited to protrusions that have a regular protrusion pattern or the protrusion patterns illustratively provided here.

If desired, the oral device 10 of FIG. 1 can be used with toothpaste that is applied to the head portion 12.

Embodiments of the oral device 10, 100 can involve a protrusion by way of reverse arrangement involving an indent.

It is also contemplated that the stop portion 14, 114 and head portion 12, 112 (or other like features) are combined into one or into overlapping features such as by having a head portion 12, 112 that widens to providing a block or assist with the blocking action.

Any of the features or attributes of the above described embodiments and variations can be used in combination with any of the other features and attributes of the above described embodiments and variations as desired. For example, if desired, features of embodiments in FIG. 1 and FIG. 8 can be interchanged or combined to arrive at various combinations of features. All numerical ranges described above with respect to the illustrative embodiments are inclusive of all numerical values within the range as well as the two endpoints of the range. Also, when the term “about” or “approximately” is used before reciting a range or value, it means that the value (or the value in the range) can vary by as much as ±10% to in some case ±25% and that term is applicable to each recited value or value in the range.

Although the oral device 10 has been shown and described with respect to certain embodiments, it is apparent that the aforedescribed oral device 10 can be embodied in many different forms and that many other modifications and variations are possible without departing from the spirit and scope of the claimed invention.

Moreover, while exemplary embodiments have been described herein, one of ordinary skill in the art will readily appreciate that the exemplary embodiments set forth above are merely illustrative in nature and should not be construed as to limit the claims in any manner. Rather, the scope of the invention is defined only by the appended claims and their equivalents, and not, by the preceding description.

The invention claimed is:

1. An oral device for a baby, comprising:
a head portion, the head portion including one of: (i) a plurality of bristles for brushing gums and/or teeth of a baby, or (ii) a plurality of protrusions for stimulating gums and/or emerging teeth of the baby;
a stop portion connected to the head portion, the stop portion sized to prevent over-insertion of the oral device into the mouth of the baby; and
a handle portion connected to the stop portion, the handle portion configured to be grasped by the baby or another person for holding and/or manipulating the oral device.

2. The oral device according to claim 1, wherein the head portion comprises the plurality of bristles for brushing gums and/or teeth of the baby, and the head portion further comprises a central stem portion connected to the stop portion, the plurality of bristles extending from one or more sides of the central stem portion.

3. The oral device according to claim 2, wherein the plurality of bristles of the head portion are arranged around the entire circumference of the central stem portion.

4. The oral device according to claim 1, wherein the head portion comprises the plurality of protrusions for stimulating gums and/or emerging teeth of the baby, and the head portion further comprises a central stem portion connected to the stop portion, the plurality of protrusions extending outwardly from one or more sides of the central stem portion.

5. The oral device according to claim 4, wherein the plurality of protrusions of the head portion are arranged around the entire circumference of the central stem portion.

6. The oral device according to claim 1, wherein the stop portion is in a shape of an animal head.

7. The oral device according to claim 6, wherein the animal head forming the stop portion is a bear head.

8. The oral device according to claim 1, wherein the handle portion comprises a base portion and a shaft portion connected to the base portion, the shaft portion of the handle portion being connected to the stop portion.

9. The oral device according to claim 8, wherein the base portion of the handle portion comprises one or more protrusions extending from one or more outer surfaces of the base portion.

10. The oral device according to claim 9, wherein the base portion has a substantially disk shape, and the one or more protrusions extend from one or more outer disk surfaces.

11. The oral device according to claim 1, wherein the handle portion comprises a loop portion connected to the stop portion.

12. The oral device according to claim 11, wherein the loop portion comprises one or more protrusions extending from one or more outer surfaces of the loop portion.

13. The oral device according to claim 1, wherein the stop portion comprises one or more protrusions extending from one or more outer surfaces of the stop portion.

14. The oral device according to claim 13, wherein the stop portion is in a shape of an animal head, and the one or more protrusions extend from one or more outer ear surfaces of the animal head.

15. The oral device according to claim 1, wherein the oral device is formed from a flexible polymeric material.

16. The oral device according to claim 15, wherein the flexible polymeric material forming the oral device comprises silicone.

17. The oral device according to claim 15, wherein the flexible polymeric material forming the oral device does not comprise latex, bisphenol A, or polyvinyl chloride.

18. An oral device for a baby, comprising:
a head portion, the head portion including one of: (i) a plurality of bristles for brushing gums and/or teeth of a baby, or (ii) a plurality of protrusions for stimulating gums and/or emerging teeth of the baby;
a stop portion connected to the head portion, the stop portion sized to prevent over-insertion of the oral device into the mouth of the baby; and
a handle portion connected to the stop portion, the handle portion configured to be grasped by the baby or another person for holding and/or manipulating the oral device, the handle portion including one of: (i) a base portion and a shaft portion, the shaft portion connecting the base portion to the stop portion, or (ii) a loop portion connected to the stop portion.

19. The oral device according to claim 18, wherein the handle portion comprises the base portion and the shaft portion, the base portion having a substantially disk shape.

20. The oral device according to claim 18, wherein the handle portion comprises the loop portion, the loop portion being in a form of an enclosed loop configured to be grasped by the baby or the other person.
